(19) United States
(12) Patent Application Publication
(10) Pub. No.: US 2017/0334395 A1
(43) Pub. Date: Nov. 23, 2017

(54) SMART KEY GENERATING DEVICE, AUTOMOBILE, AND METHOD FOR CONTROLLING THE AUTOMOBILE BY USING THE SMART KEY

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN LU, Shenzhen (CN); HUAN-HUAN ZHANG, Shenzhen (CN); DONG-SHENG LV, Shenzhen (CN)

(21) Appl. No.: 15/594,660

(22) Filed: May 15, 2017

(30) Foreign Application Priority Data
May 18, 2016 (CN) 201610334489.5

(51) Int. Cl. B60R 25/24

(52) U.S. Cl. CPC B60R 25/24

(57) ABSTRACT

A smart key generating device which can generate and transmit a smart key to open and drive an automobile operates within an environment of three electronic devices, one device being in the automobile, one in a device held by automobile owner, and one in a device held by borrower or potential borrower of automobile. The automobile verifies information of a smart key received to determine whether a sender of the key is authorized. If the information in the smart key is verified, the holder of the sending device can be permitted by the automobile to use it, subject to conditions which can be imposed. The automobile can be started by the smart key alone, physical key cannot be necessary.

### CROSS-REFERENCE TO RELATED APPLICATIONS

This application claims priority to Chinese Patent Application No. 201610334489.5 filed on May 18, 2016.

### FIELD

The subject matter herein generally relates to smart keys for automobiles, and particularly to a smart key for an automobile and a method for controlling the automobile by using the smart key.

### BACKGROUND

In general, physical keys are needed to start an automobile. However, the physical key is not convenient. For example, if a person wants to borrow an automobile, he/she must get the physical key of the automobile from the owner of the automobile. Besides, the physical keys may be easily lost.

### BRIEF DESCRIPTION OF THE DRAWINGS

Implementations of the present technology will now be described, by way of example only, with reference to the attached figures.

FIG. 1 is a block diagram illustrating an exemplary embodiment of an operating environment of a smart key generating system.

FIG. 2 is a block diagram illustrating an exemplary embodiment of the smart key generating device of FIG. 1.

FIGS. 3-6 illustrate a flowchart of an exemplary embodiment of a method for controlling an automobile by using a smart key.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

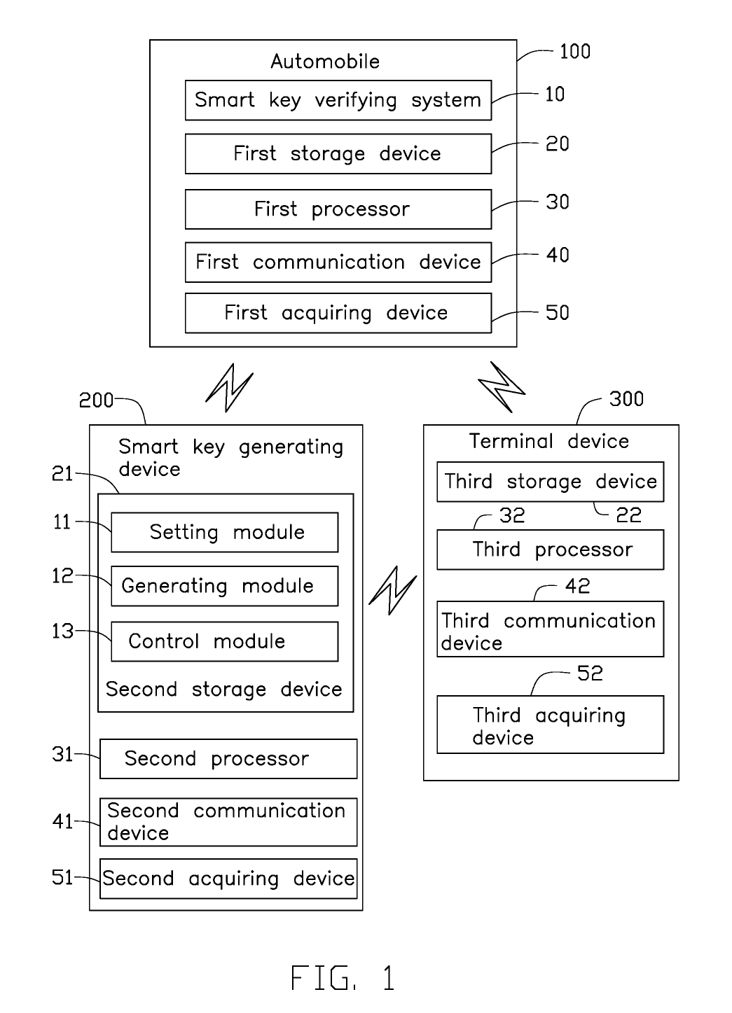

FIG. 1 illustrates an exemplary embodiment of an operating environment of a smart key generating device 200. The smart key generating device 200 can communicate with at least one automobile 100 and at least one terminal device 300. The smart key generating device 200 is configured to generate a smart key for the automobile 100, the automobile 100 verifies information of the smart key to determine whether a user of the smart key generating device 200 is authorized to start the automobile 100. If the information in the smart key is verified, the automobile 100 can be started by the smart key. By using the smart key, the automobile 100 can be started without physical keys. The smart key generating device 200 further can communicate with a terminal device 300 and transmit the smart key to the terminal device 300, thus the user of the terminal device 300 can start the automobile 100 by using his/her terminal device 300.

In the exemplary embodiment, the smart key generating device 200 can be a portable electronic device, such as a smart phone, a table computer, or the like. For example, the smart key generating device 200 can be a mobile phone of an owner of the automobile 100. The terminal device 300 also can be a portable electronic device, such as a smart phone, a table computer, or the like. For example, the terminal device 300 can be a mobile phone of a borrower of the automobile 100, for example a friend or a family member of the owner of the automobile 100.

In the exemplary embodiment, the smart key generating device 200 is a mobile phone of an owner of the automobile 100, and the terminal device 300 is a mobile phone of a person authorized to use the automobile 100, is taken as an example to describe the present disclosure.

In the exemplary embodiment, the automobile 100 can include, but is not limited to, a smart key verification system 10, a first storage device 20, a first processor 30, a first communication device 40, and a first acquiring device 50. The smart key generating device 200 can include, but is not limited to, a second storage device 21, a second processor 31, a second communication device 41, and a second acquiring device 51. The terminal device 300 can include, but is not limited to, a third storage device 22, a third processor 32, a third communication device 42, and a third acquiring device 52.

In the exemplary embodiment, the first storage device 20 can be, but is not limited to, an internal storage system of the automobile 100, such as a flash memory, a random access memory (RAM) for temporary storage of information, and/or a read-only memory (ROM) for permanent storage of information. The first storage device 20 can also be a storage system, such as a hard disk, a storage card, or a data storage medium. The first processor 30 can be, but is not limited to, a central processing unit, a digital signal processor, or a single chip, for example. The first processor 30 can be built into the automobile 100. The first processor 30 further can be external component. The first communication device 40 can be, but is not limited to, a BLUETOOTH module, a WI-FI module, or a ZIGBEE module. The first acquiring device 50 is configured to obtain biometric information of users. For example, the first acquiring device 50 can be a camera configured to acquire face images of the users. The first acquiring device 50 also can be a fingerprint reader configured to acquire fingerprint information of the users.

In the exemplary embodiment, the second storage device 21 and the third storage device 22 can be, but are not limited to, an internal storage system, such as a flash memory, a random access memory (RAM) for temporary storage of information, and/or a read-only memory (ROM) for permanent storage of information. The second storage device 21 and the third storage device 22 can also be a storage system, such as a hard disk, a storage card, or a data storage medium. The second processor 31 and the third processor 32 can be, but are not limited to, a central processing unit, a digital signal processor, or a single chip, for example. The second communication device 41 and the third communication device 42 can be , but are not limited to, a BLUETOOTH module, a WI-FI module, or a ZIGBEE module. The second acquiring device 51 and the third acquiring device 52 are configured to obtain biometric information of users. For example, the second acquiring device 51 and the third acquiring device 52 can be cameras configured to acquire face images of the users. The second acquiring device 51 and the third acquiring device 52 further can be fingerprint readers configured to acquire fingerprint information of the users.

In the exemplary embodiment, the second storage device 21 of the smart key generating device 200 stores a number of modules, which are a collection of software instructions that can be respectively executed by the second processor 31. In the exemplary embodiment, the modules can include a setting module 11, a generating module 12, and a control module 13.

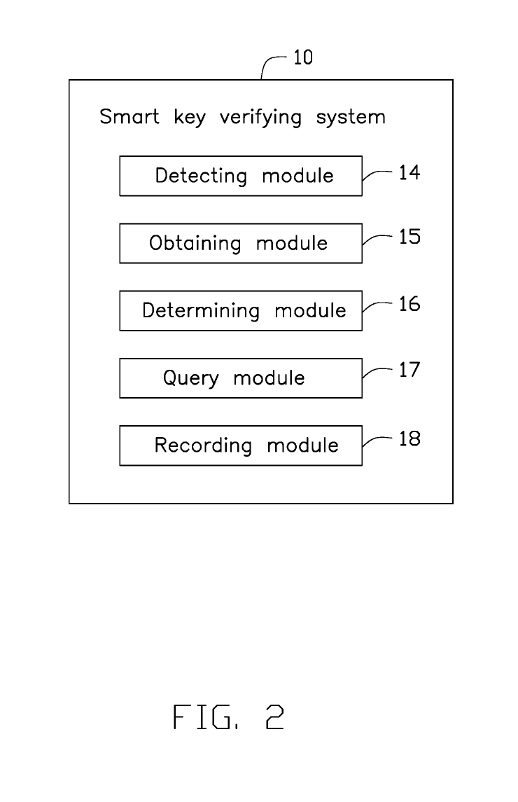

In the exemplary embodiment, the smart key verification system 10 can include a number of modules, which are a collection of software instructions stored in the first storage device 20 and executed by the first processor 30. Referring to FIG. 2, in at least one embodiment, the smart key verification system 10 can include a detecting module 14, an obtaining module 15, a determining module 16, a query module 17, and a recording module 18.

In an alternative embodiment, the setting module 11, the generating module 12, and the control module 13, the detecting module 14, the obtaining module 15, the determining module 16, the query module 17, and the recording module 18 can be stored in each of the first storage device 20 and the second storage device 21, and executed by the first processor 30 and the second processor 31.

The setting module 11 controls the smart key generating device 200 to provide a user interface for the owner of the automobile 100 to input automobile information, user information of one or more users, and use-permission information of each of the users.

In the exemplary embodiment, the automobile information can include, but is not limited to, a type of the automobile 100, a color of the automobile 100, a license plate number of the automobile 100, and other identifications of the automobile 100.

In the exemplary embodiment, the user information can include, but is not limited to, identity information of the user and biometric information of the user. The identity information of the user can include, but is not limited to, a name of the user, a gender of the user, an age of the user, and the like. The biometric information of the user can include, but is not limited to, facial features of the user, fingerprint information of the user, and the like. In the exemplary embodiment, the biometric information is fingerprint information of the user acquired by the second acquiring device 51 or the third acquiring device 52. In the exemplary embodiment, the user information can be information of the owner of the automobile 100, and also can be information of other persons who may need the automobile 100. In the exemplary embodiment, the user information can be inputted by the owner of the automobile 100, and also can be received from other terminal devices, for example the terminal device 300. The user information can be input by the owner of the automobile 100 when the owner of the automobile 100 uses the smart key for the first time. The user information further can be received from other terminal devices of people who might need to use the automobile 100.

In the exemplary embodiment, the use-permission information can include, but is not limited to, a usage time, a time duration that the automobile 100 is allowed to be used, and a travel distance threshold or ceiling. For example, if the user is the owner of the automobile 100, the usage time can be anytime, the time duration is unlimited, and the travel distance is unlimited. If the user is a borrower of the automobile 100, the usage time can be from 8:00 AM to 12:00 AM. A time duration can be 3 hours. The travel distance can be 500 kilometers. Thus, the borrower of the automobile 100 only can use the automobile 100 within the time period 8:00 AM to 12:00 AM, for not more than 3 hours, and travel only 500 kilometers or less.

The generating module 12 generates an identification code according to the automobile information inputted by the owner of the automobile 100. In the exemplary embodiment, each automobile 100 corresponds to one unique identification code.

The control module 13 transmits the identification code, the user information of the one or more users and use-permission information of each user to the automobile 100. The automobile 100 stores the identification code, the user information of the one or more users and use-permissions information of each user, to the first storage device 20.

The generating module 12 further generates the smart key according to the identification code, the one or more user information, and use-permission information of each user. The smart key can include the identification code and the user information. The generating module 12 further stores the smart key to the second storage device 21 or transmits the smart key to the terminal device 300. In detail, if the user information is about the owner of the automobile 100, the generating module 12 stores the smart key to the second storage device 21. If the user information is received from the terminal device 300, the generating module 12 transmits the smart key to the terminal device 300.

When the automobile 100 is in a locked state, the detecting module 14 detects at intervals whether a smart key is within a first preset range around the automobile 100. In detail, the detecting module 14 detects whether a terminal device (for example the smart key generating device 200 or the terminal device 300), which can establish a communication with the first communication device 40, is within the first preset range. If the detecting module 14 determines that there is one terminal device can establish communication with the first communication device 40, the control module 13 controls the first communication device 40 to establish the communication with the terminal device, for example the smart key generating device 200 or the terminal device 300. The detecting module 14 detects whether the smart key is stored in the terminal device.

If the detecting module 14 determines that the terminal device stores the smart key, the obtaining module 15 obtains the user information and the identification code of the automobile 100 from the smart key.

The determining module 16 determines whether the identification code obtained from the smart key matches with the identification code stored in the first storage device 20. If the determining module 16 determines that the identification code obtained from the smart key matches the identification code stored in the first storage device 20, the query module 17 searches in the first storage device 20 to determine whether a user information matches with the user information obtained from the smart key. If the query module 17 determines that there is a user information which matches the user information obtained from the smart key, the control module 13 controls the automobile 100 to unlock the door of the automobile 100.

When the door of the automobile 100 is unlocked, the determining module 16 further determines whether a biometric information of the user obtained by the first acquiring device 50 matches with a biometric information of the user stored in the first storage device 20. If the determining module 16 determines that the biometric information of the user matches with a biometric information of the user stored in the first storage device 20, the query module 17 obtains the use-permission information corresponding to the biometric information. The determining module 16 determines whether the user has a permission to use the automobile 100 at the current time according to the user-permission information. If the determining module 16 determines that the user has the permission to use the automobile 100, the control module 13 sends a command to the engine of the automobile 100 to control the engine of the automobile 100 to start.

In an alternative embodiment, once the determining module 16 determines that the biometric information of the user matches with a biometric information of the user stored in the first storage device 20, the control module 13 sends a command to the engine of the automobile 100 to control the engine of the automobile 100 to start.

The recording module 18 starts to record a usage log of the automobile 100 once the door of the automobile 100 is unlocked or the engine of the automobile 100 is started. In the exemplary embodiment, the usage log can include the current time, the time duration of the automobile 100 being used, the distance travelled of the automobile 100, and the current location of the automobile 100.

The determining module 16 determines compliance with the use-permission of the user. For example, by determining whether the current time is within the permitted hours, whether the time duration that the automobile 100 has been used exceeds the time duration of the use-permission information, and whether the travel distance of the automobile 100 exceeds the permitted distance. If at least one of the usage time, the time duration, and the travel distance exceeds the use-permission information, the determining module 16 determines that the use-permission is expired or breached, and the control module 13 can forbid the usage of the automobile 100 by using a preset method. In the exemplary embodiment, the preset method can include one or more of the following methods: locking the door of automobile 100, turning off the engine of the automobile 100. In an alternative embodiment, if the automobile 100 is running on the road when the determining module 16 determines that the user can no longer use the automobile 100, the preset method can be that the engine is forbidden to be started by the user after the engine is next turned off.

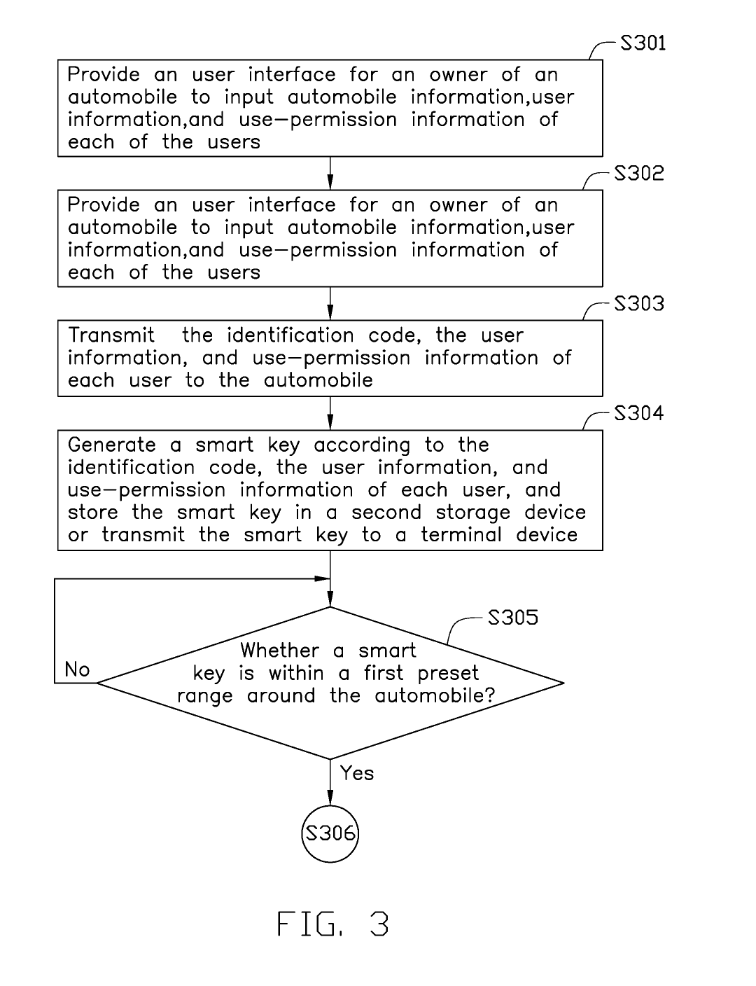

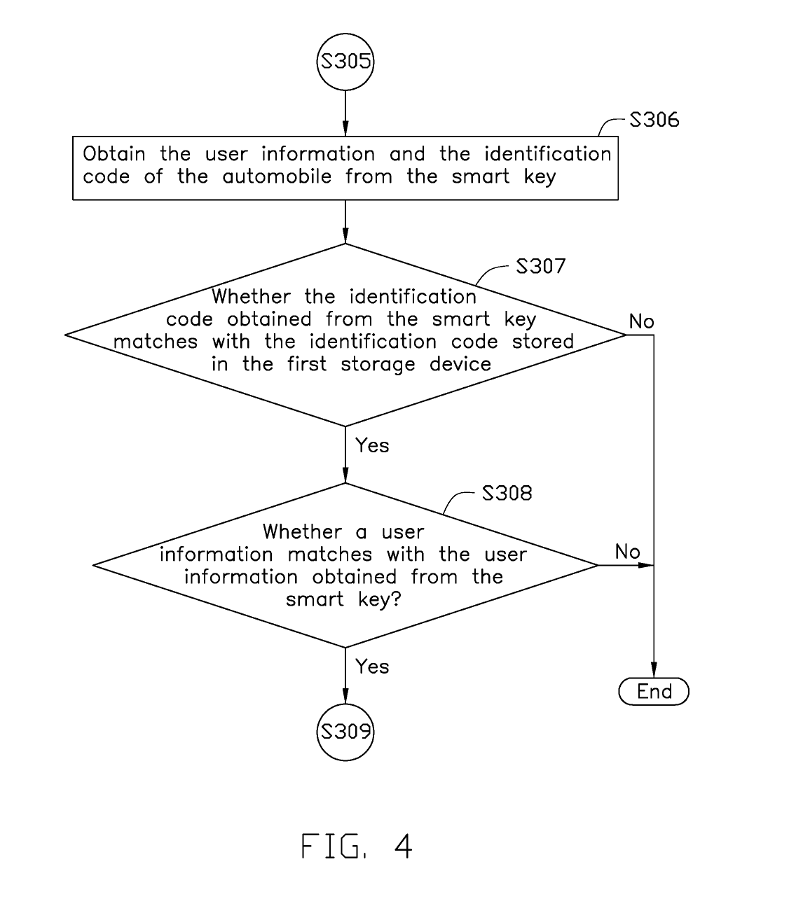

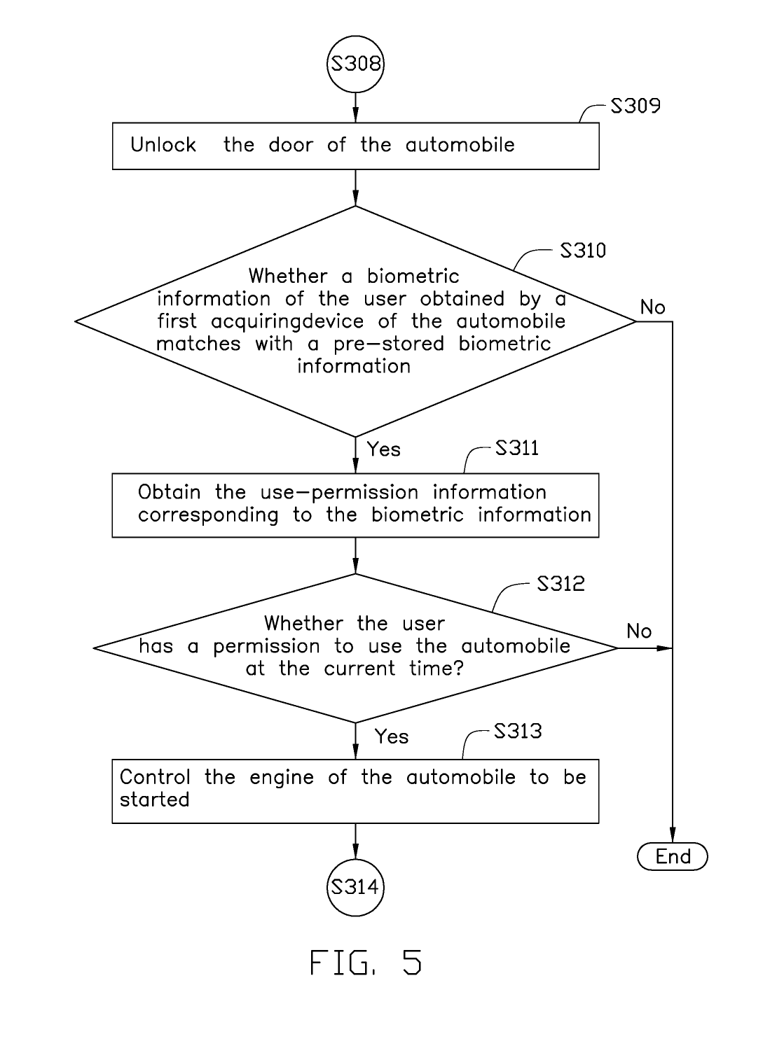

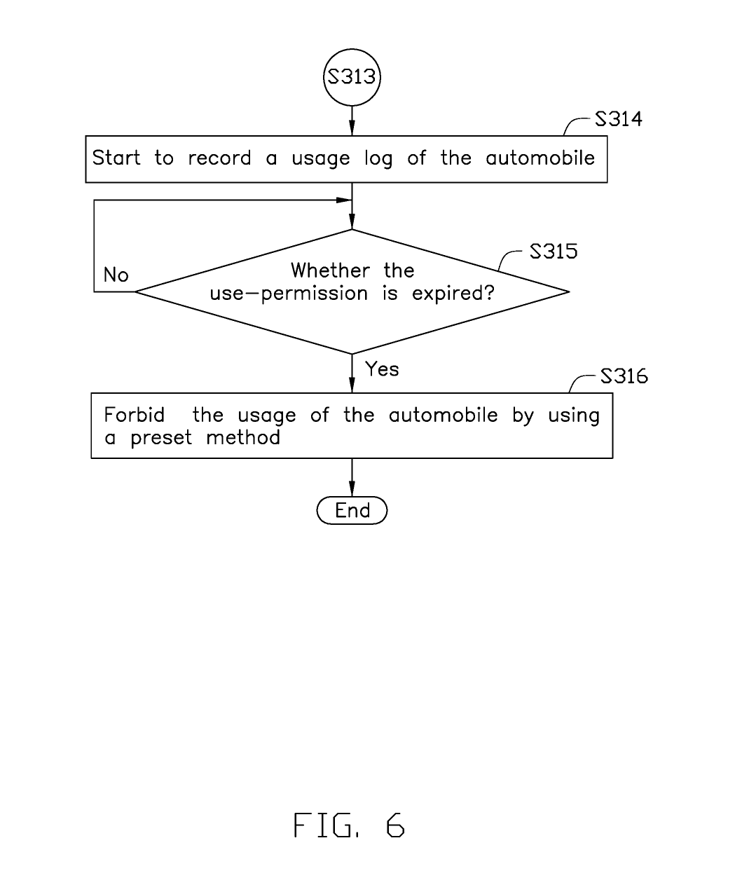

A method for controlling an automobile by using a smart key is illustrated in FIG. 3 to FIG. 6. The method is provided by way of example, as there are a variety of ways to carry out the method. Each block shown in FIGS. 3-6 represent one or more processes, methods, or subroutines carried out in the example method. Additionally, the illustrated order of blocks is by example only and the order of the blocks can be changed. The example method can begin at block S301.

At block S301, a setting module of a smart key generating device provides an user interface for an owner of an automobile to input automobile information, user information of one or more users, and use-permission information of each of the users.

At block S302, the generating module generates an identification code according to the automobile information inputted by the owner of the automobile. In the exemplary embodiment, each automobile corresponds to one unique identification code.

At block S303, a control module transmits the identification code, the user information of the one or more users, and use-permission information of each user to the automobile. The automobile stores the identification code, the user information of the one or more users and use-permission information of each user to a first storage device.

At block S304, the generating module generates a smart key according to the identification code, the user information of one or more users, and use-permission information of each user, and stores the smart key in a second storage device or transmits the smart key to a terminal device. The smart key can include the identification code and the user information.

In at least one embodiment, if the user information and the automobile information are previously stored in the smart key generating device, the block S301-S304 can be omitted.

At block 305, a detecting module of the automobile detects at intervals whether a smart key is within a first preset range around the automobile, when the automobile is in a locked state. If the automobile determines that there is one smart key existing in the first preset range, the procedure goes to block S306, otherwise, the procedure repeats the block S305.

At block S306, an obtaining module obtains the user information and the identification code of the automobile from the smart key.

At block S307, a determining module determines whether the identification code obtained from the smart key matches with the identification code stored in the first storage device. If the automobile determines that the identification code obtained from the smart key matches one of the identification codes stored in the first storage device, the procedure goes to block S308, otherwise, the procedure is ended.

At block S308, a query module searches in the first storage device to determine whether a user information matches with the user information obtained from the smart key. If the automobile determines that there is a user information which matches the user information obtained from the smart key, the procedure goes to block S309, otherwise, the procedure is ended.

At block S309, the automobile unlocks the door of the automobile.

At block S310, the determining module determines whether a biometric information of the user obtained by a first acquiring device of the automobile matches with a biometric information of the user stored in the first storage device. If the determining module determines that the biometric information of the user matches with a biometric information of the user stored in the first storage device, the procedure goes to block S311, otherwise, the procedure is ended. In an alternative embodiment, if the determining module determines that the biometric information of the user matches a biometric information of the user stored in the first storage device, the procedure directly goes to block S313.

At block S311, the query module obtains the use-permission information corresponding to the biometric information.

At block S312, the determining module determines whether the user has a permission to use the automobile at the current time according to the use-permission information. If the determining module determines that the user has the permission to use the automobile, the procedure goes to block S313, otherwise, the procedure is ended.

At block S313, the control module controls the engine of the automobile to be started.

At block S314, a recording module starts to record a usage log of the automobile once the door of the automobile is unlocked or the engine of the automobile 100 is started. In the exemplary embodiment, the usage log can include the current time, the time duration of the automobile being used, the distance travelled of the automobile, and the current location of the automobile.

At block S315, the determining module determines whether the use-permission is expired by determining whether the current time is within the permitted hours, whether the time duration that the automobile has been used exceeds the time duration of the use-permission information, and whether the travel distance of the automobile exceeds the travel distance threshold. If at least one of the usage time, the time duration, and the travel distance is determined to exceed the use-permission information, the procedure goes to block S316, otherwise, the procedure repeats the block S315.

At block S316, the control module forbids the usage of the automobile by using a preset method. In the exemplary embodiment, the preset method can include one or more of the following methods: locking the door of automobile, turning off the engine of the automobile. In an alternative embodiment, if the automobile is running on the road when the determining module determines that the user can no longer use the automobile, the preset method can be that the engine is forbidden to be started by the user after the engine is next turned off.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An automobile comprising:
a first communication device to communicate with at least one smart key generating device;
a first processor;
a first storage device storing one or more programs, when executed by the first processor, the one or more programs cause the first processor to:
detect at intervals whether a smart key, which is generated by the smart key generating device and comprises an identification code of the automobile and user information, is within a first preset range around the automobile when the automobile is in a locked state;
obtain the user information and the identification code from the smart key if determining that the smart key exists within the first preset range around the automobile;
determine whether the identification code obtained from the smart key matches one of identification codes pre-stored in the first storage device;
determine whether the user information obtained from the smart key matches a user information pre-stored in the first storage device if determining that the identification code obtained from the smart key matches one of the identification codes pre-stored in the first storage device; and
control the automobile to unlock if determining that the user information obtained from the smart key matches one of the user information pre-stored in the first storage device.

2. The automobile of claim 1, further comprising a first acquiring device to acquire user information, wherein the programs further cause the first processor to:
determine whether the user information acquired by the first acquiring device matches the user information pre-stored in the first storage device; and
control the automobile to start if determining that the user information acquired by the first acquiring device matches one of the user information pre-stored in the first storage device.

3. The automobile of claim 2, wherein the first storage device further stores use-permission information associating with each user information, the programs further cause the first processor to:
acquire the use-permission information corresponding to the user information obtained from the smart key if the user information acquired by the first acquiring device matches one of the user information pre-stored in the first storage device;
determine whether the user has a permission to use the automobile at the current time according to the use-permission information; and
start the automobile if determining that the user has a permission to use the automobile at the current time.

4. The automobile of claim 3, wherein the programs further cause the first processor to:
record a usage log of the automobile once the automobile is unlocked;
determine whether the use-permission is expired; and
forbid an usage of the automobile by using a preset method if determining that the use-permission is expired.

5. The automobile of claim 4, wherein the use-permission comprises a usage time, a time duration that the automobile is allowed to be used, and a travel distance threshold; the first processor determines whether the use-permission is expired by determining whether at least one of the current time, the time duration that the automobile has been used, and the travel distance exceeds the use-permission information.

6. The automobile of claim 4, wherein the preset method is selected from a group consisting of:
locking a door of automobile;
turning off an engine of the automobile; and
forbidding the engine of the automobile to be started by the user after the engine is turned off.

7. A smart key generating device comprising:
a second communication device to communicate with an automobile;
a second processor; and
a second storage device storing one or more programs, when executed by the second processor, the one or more programs cause the second processor to:
provide a user interface for an owner of the automobile to input automobile information, and user information of one or more users;
generate an identification code of the automobile according to the automobile information; and
transmit the identification code and the user information to the automobile; and
generate a smart key according to the identification code and the user information, the smart key being configured to start the automobile when is verified by the automobile.

8. The smart key generating device of claim 7, wherein the user information comprises information of an owner of the automobile inputted by the owner of the automobile, the user information further comprises information of a borrower of the automobile that is received from a terminal device communicated with the smart key generating device; the second processor generates the smart key according to the inputted user information and stores the smart key to the second storage device if the user information is inputted by the owner of the automobile; the second processor generates the smart key according to the received user information and transmits the smart key to the terminal device if the user information is received from the terminal device.

9. The smart key generating device of claim 7, wherein the user interface is further for the users to set use-permission information of each user, the use-permission information comprises a usage time, a time duration that the automobile is allowed to be used, and a travel distance threshold.

10. A method for controlling an automobile by using a smart key comprising:
detecting at intervals, by the automobile, whether a smart key, which is generated by a smart key generating device and comprises an identification code of the automobile and user information, is within a first preset range around the automobile when the automobile is in a locked state;
obtaining, by the automobile, the user information and the identification code from the smart key if determining that the smart key exists within the first preset range around the automobile;
determining, by the automobile, whether the identification code obtained from the smart key matches one of identification codes pre-stored in the automobile;
determining, by the automobile, whether the user information obtained from the smart key matches one of user information pre-stored in the automobile if determining that the identification code obtained from the smart key matches one of the identification codes pre-stored in the automobile; and
unlocking the automobile if determining that the user information obtained from the smart key matches one of the user information pre-stored in the automobile.

11. The method for controlling an automobile by using a smart key of claim 10, further comprising:
providing a user interface in the smart key generating device for an owner of the automobile to input automobile information, and user information of one or more users;
generating an identification code of the automobile, by the smart key generating device, according to the automobile information;
transmitting the identification code and the user information to the automobile; and
generating a smart key according to the identification code and the user information, the smart key being to start the automobile when is verified by the automobile.

12. The method for controlling an automobile by using a smart key of claim 10, further comprising:
determining, by the automobile, whether user information acquired by a first acquiring device matches the user information pre-stored in the automobile; and
controlling the automobile to start if determining that the user information acquired by the first acquiring device matches one of the user information pre-stored in the automobile.

13. The method for controlling an automobile by using a smart key of claim 12, further comprising:
acquiring an use-permission information corresponding to the user information obtained from the smart key if the user information acquired by the first acquiring device matches one of the user information pre-stored in the automobile;
determining whether the user has a permission to use the automobile at the current time according to the use-permission information; and
starting the automobile if determining that the user has a permission to use the automobile at the current time.

14. The method for controlling an automobile by using a smart key of claim 10, further comprising:
recording a usage log of the automobile once the automobile is unlocked;
determining whether the use-permission is expired; and
forbidding an usage of the automobile by using a preset method if determining that the use-permission is expired.

15. The method for controlling an automobile by using a smart key of claim 13, wherein the use-permission information comprises a usage time, a time duration that the automobile allowed to be used, and a travel distance threshold, the automobile determines whether the use-permission is expired by determining whether at least one of the current time, the time duration that the automobile has been used, and the travel distance exceeds the use-permission information.
